(19) United States
(12) Patent Application Publication
(10) Pub. No.: US 2026/0027997 A1
(43) Pub. Date: Jan. 29, 2026

(54) KING PIN PRESS TOOL

(71) Applicant: Tiger Tool International Incorporated, Abbotsford (CA)

(72) Inventor: Rudolf Maksymilian Klossok, Coquitlam (CA)

(73) Assignee: Tiger Tool International Incorporated, Abbotsford, BC (CA)

(21) Appl. No.: 19/276,859

(22) Filed: Jul. 22, 2025

Related U.S. Application Data
(60) Provisional application No. 63/674,975, filed on Jul. 24, 2024.

(51) Int. Cl. B60S 5/00

(52) U.S. Cl. CPC B60S 5/00

(57) ABSTRACT

A press tool for displacing a first part along a drive axis relative to a second part comprises a drive plate defining a drive opening, an anchor plate, a drive screw assembly, and a spacing system. The drive screw assembly comprises a drive screw member and a drive screw cap. The spacing system supports the drive plate and the anchor plate relative to first part such that the drive screw member and the first part are aligned with the drive axis. The drive screw member engages the drive plate such that rotation of the drive screw member relative to the drive plate assembly displaces the drive screw through the drive opening to displace the first part along the drive axis relative to the second part.

### RELATED APPLICATIONS

This application (Attorney's Ref. No. P220679) claims benefit of U.S. Provisional Application Ser. No. 63/674,975 filed Jul. 24, 2025, the contents of which are incorporated herein by reference.

### TECHNICAL FIELD

The present invention relates to systems and methods for removing the king pin from a king pin assembly.

### BACKGROUND

A king pin is commonly used to connect an axle member to a knuckle assembly used as a part of a steering system for trucks and other large vehicles. King pins are subjected to harsh operating environments and typically need to be removed and replaced when damaged or in accordance with a predetermined maintenance schedule. The process of removing and replacing king pins is generally well known and will not be described herein beyond that extent helpful to a complete understanding of the present invention.

A king pin press is a tool used to displace a king pin relative to the axle member and knuckle assembly. A king pin press is subjected to significant forces when used to displace a king pin. A first example of a king pin press is disclosed, for example, in U.S. Pat. No. 9,511,488. A second example of a king pin press is also disclosed in co-pending U.S. patent application Ser. No. 18/642,359, the contents of which are incorporated herein by reference.

The need exists for a king pin press that is easy to operate and avoids premature wear and failure.

### BRIEF DESCRIPTION OF THE DRAWINGS

FIG. 1 is a side elevation exploded view of a first example king pin press tool of the present invention and also illustrating an axle and a knuckle assembly from which a king pin (not visible) is to be removed;

FIG. 2 is a top perspective view of a first example drive plate assembly of the first example king pin press tool of the present invention;

FIG. 3 is a top plan view of the first example drive plate assembly;

FIG. 4 is a perspective view of a drive sleeve of the first example drive plate assembly;

FIG. 5 is a side elevation section view of the first example king pin press tool at the beginning of the process of removing a king pin from an axle and a knuckle assembly;

FIG. 6 is a section view taken along lines 6-6 in FIG. 5;

FIG. 7 is a side elevation section view of the first example king pin press tool during the process of removing a king pin from an axle and a knuckle assembly;

FIG. 8 is an enlarged view of a portion of FIG. 5 illustrating details of a first example drive screw assembly of the first example king pin press tool;

FIGS. 9 and 10 are enlarged views similar to FIG. 8 illustrating different configurations of the first example drive screw assembly during operation the first example king pin press tool;

FIG. 11 is a side elevation view of a second example king pin press tool of the present invention illustrating a second example drive plate assembly;

FIG. 12 is a section view taken along lines 12-12 in FIG. 11; and,

FIG. 13 is a section view taken along lines 13-13 in FIG. 11.

### SUMMARY

The present invention may be embodied as a press tool for displacing a first part along a drive axis relative to a second part comprising a drive plate defining a drive opening, an anchor plate, a drive screw assembly comprising a drive screw member and a drive screw cap, and a spacing system. The spacing system supports the drive plate and the anchor plate relative to first part such that the drive screw member and the first part are aligned with the drive axis. The drive screw member engages the drive plate such that rotation of the drive screw member relative to the drive plate assembly displaces the drive screw through the drive opening to displace the first part along the drive axis relative to the second part.

The present invention may also be embodied as a press tool for displacing a first part along a drive axis relative to a second part comprising a drive plate assembly, an anchor plate, a drive screw, and a spacing system. The drive plate assembly comprises a drive plate defining a drive plate opening and a first retaining groove, a drive sleeve defining a drive sleeve opening and a second retaining groove, and a retaining member configured to fit within at least a portion of the first retaining groove and a portion of the second retaining groove. When the drive sleeve is in a desired orientation relative to the drive plate, the retaining member is arranged within at least a portion of the first retaining groove and a portion of the second retaining groove to inhibit movement of the drive sleeve relative to the drive plate. The spacing system supports the drive plate and the anchor plate relative to first part such that the drive screw member and the first part are aligned with the drive axis. The drive screw member engages the drive sleeve such that rotation of the drive screw member relative to the drive plate assembly displaces the drive screw through the drive sleeve opening to displace the first part along the drive axis relative to the second part.

The present invention may also be embodied as a method for displacing a pin member relative to a structural member, the method comprising the following steps. A drive plate assembly is provided, the drive plate assembly comprising a drive plate defining a drive plate opening and a drive sleeve defining a drive sleeve surface and drive sleeve opening. A drive screw assembly is provided, the drive screw assembly comprising a drive screw member defining a drive axis and a drive screw cap configured to engage at least a portion of the drive screw member. An anchor plate and a spacing system are provided. The drive sleeve surface is configured to engage the drive plate opening such that movement of the drive sleeve relative to the drive plate is inhibited. The spacing system is configured to support the drive plate and the anchor plate relative to the pin member such that the drive screw cap engages at least a portion of the pin member. The drive screw member is configured to engage the drive sleeve opening such that rotation of the drive screw member relative to the drive plate assembly displaces the drive screw member through the drive sleeve opening to displace the pin member along the drive axis relative to the structural member.

### DETAILED DESCRIPTION

The present invention may be embodied in different forms, and several different example embodiments of the present invention will be described in detail below.

### 1. First Example King Pin Press Tool

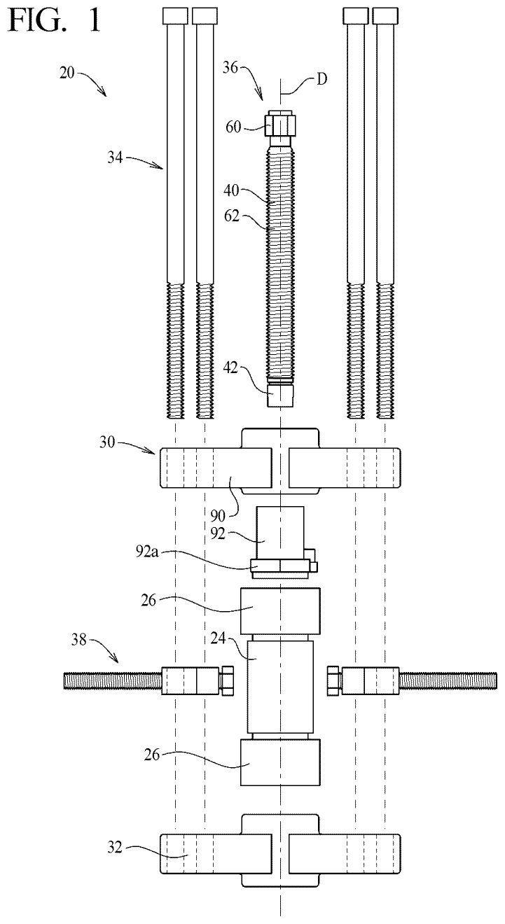

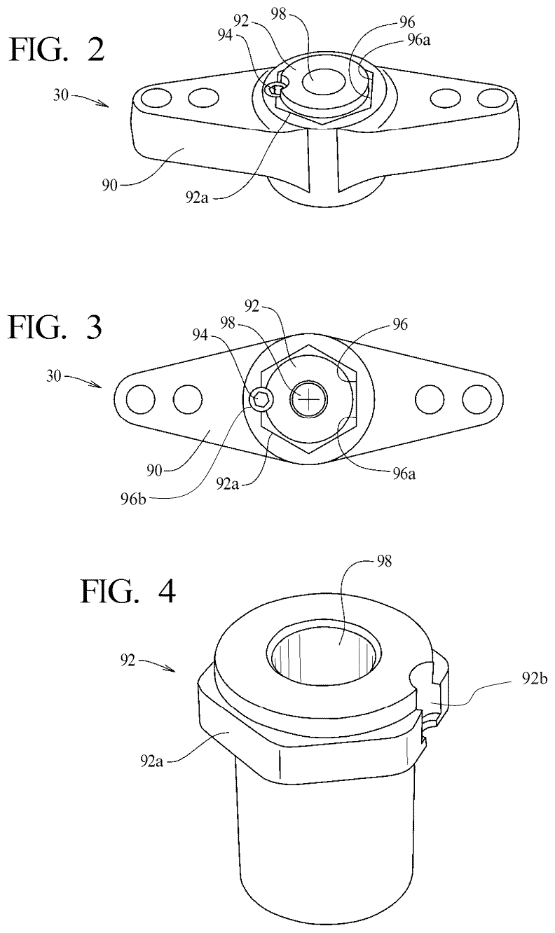

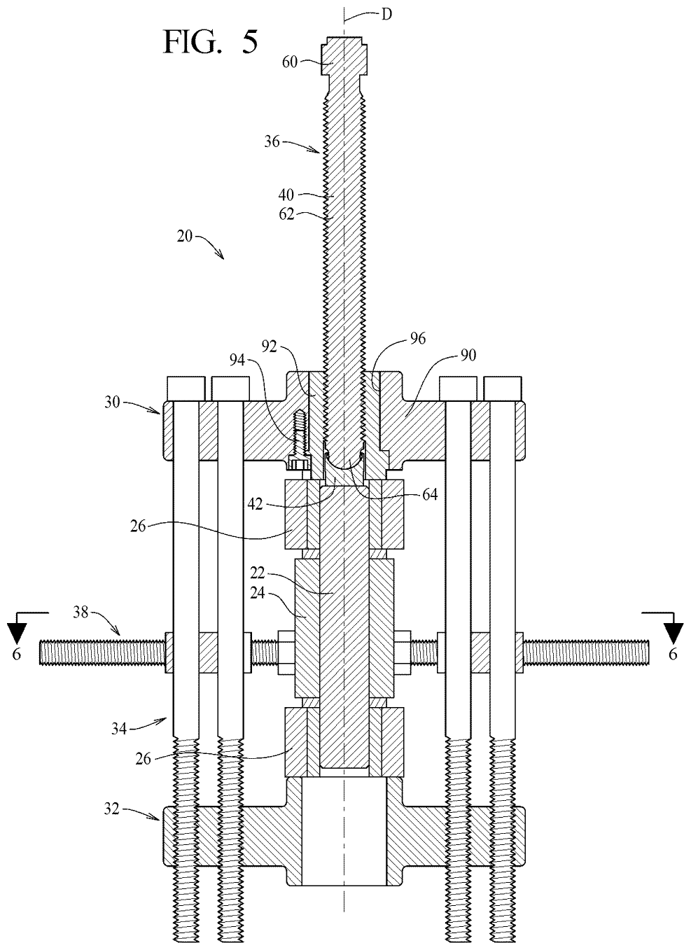

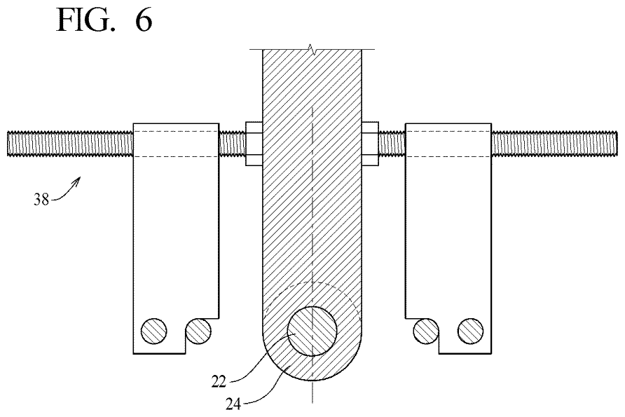

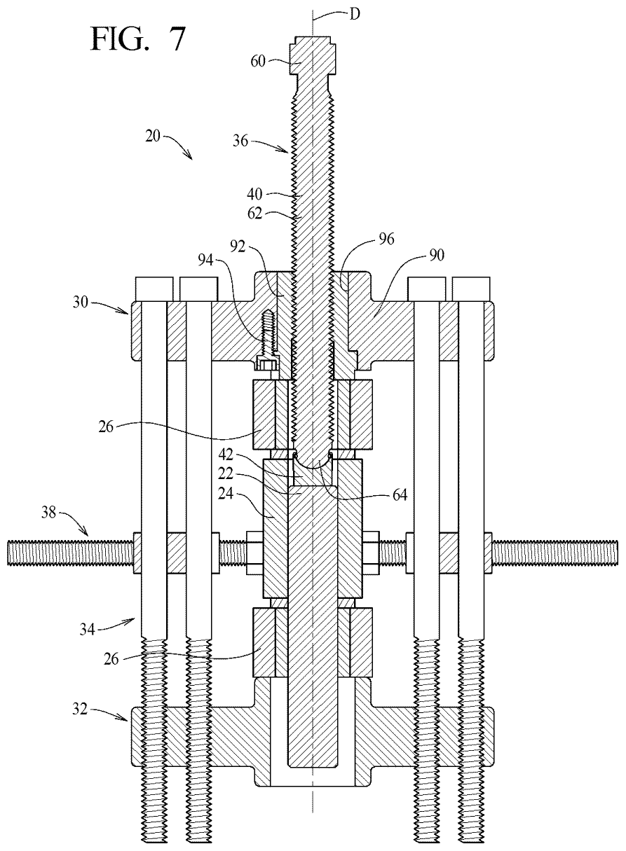

Referring initially to FIGS. 1 and 5-7 of the drawing, depicted therein is a first example king pin press tool 20 for displacing a king pin 22, or pin member, relative to structural member such as an axle 24 and/or a knuckle assembly 26. The king pin 22, axle 24, and knuckle assembly 26 are or may be conventional and will be described herein only to that extent helpful to a complete understanding of the present invention.

The first example king pin press tool 20 comprises a first example drive plate assembly 30, an anchor plate 32, a spacing system 34, a first example drive screw assembly 36, and a stabilizing system 38. The example spacing system 34 is configured to space the drive plate assembly 30 a predetermined distance from the anchor plate 32. The example drive screw assembly 36 engages the drive plate assembly 30 such that axial rotation of at least a portion of the screw assembly 36 causes the screw assembly 36 to be displaced along a drive axis D of the first example king pin press tool 20. The example stabilizing system 38 is arranged to inhibit or prevent rotation of the first example king pin press tool 20 about the drive axis D during use of the first example drive pin press tool 20 to remove the example king pin 22 from the example axle 24 and the example knuckle assembly 26.

The first example drive screw assembly 34 comprises a drive screw 40, a drive screw cap 42, and a connecting system 44. The drive screw defines the drive axis D. The connecting system 44 is configured to detachably attach the drive screw cap 42 to the drive screw 40 such that the drive screw cap 42 is movable relative to the drive screw 40. In particular, the example connecting system 44 detachably attaches the drive screw cap 42 to the drive screw 40 such that the drive screw cap 42 is rotatable relative to the drive screw 40 and such that an angle of the drive screw cap 42 relative to the drive axis D is adjustable. The example connecting system 44 comprises a cap retaining member 46 arranged to engage the drive screw 40 and the drive screw cap 42 to detachably attach the drive screw cap 42 onto the drive screw 40 as will be explained in further detail below.

The construction and operation of the first example king pin press tool 20 will now be described in detail.

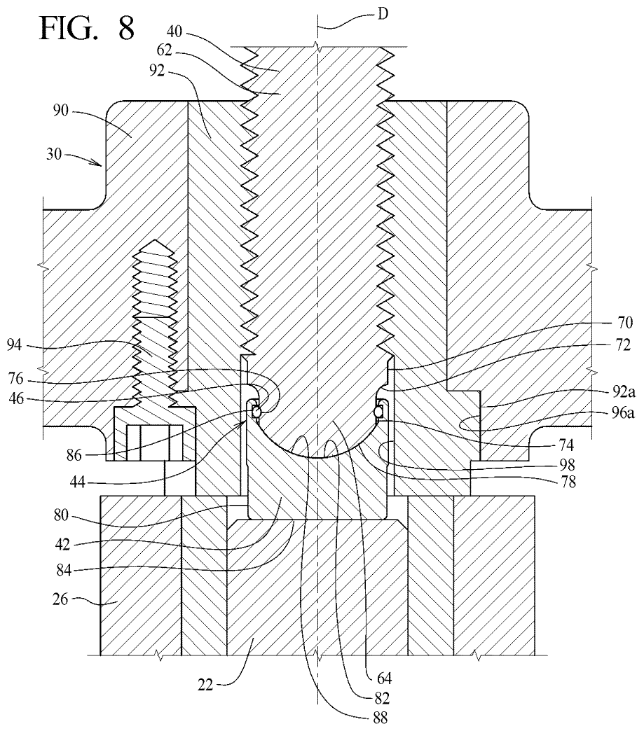

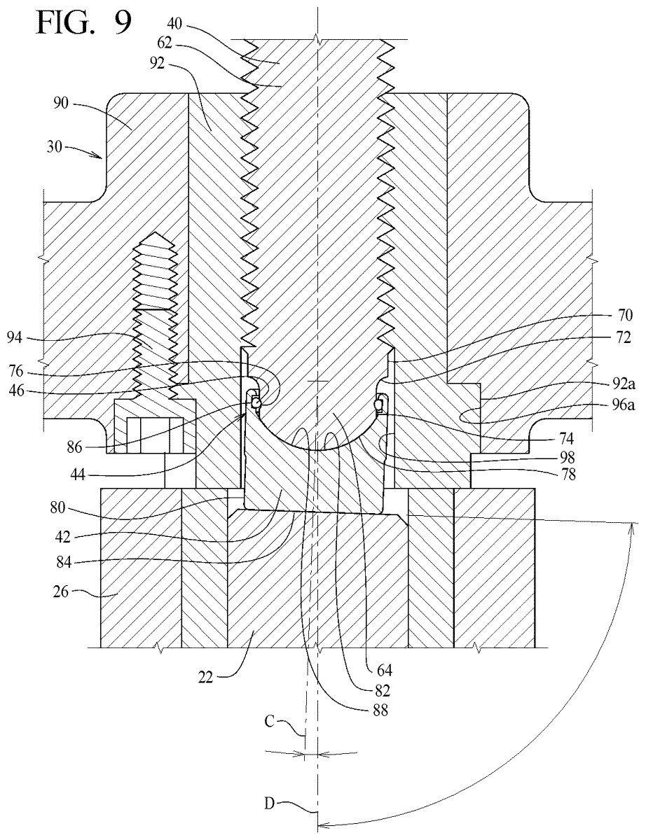

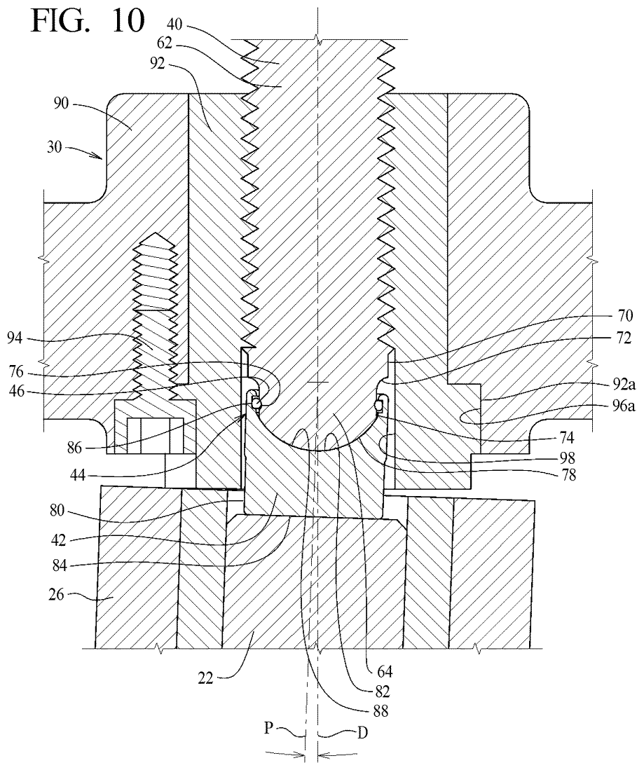

The example drive screw 40 is a rigid member defining a first end portion 60, a shaft portion 62, and a second end portion 64. The example first end portion 60 defines a hex drive configured to be driven by a conventional rotary tool (not shown), but other drive systems and connections may be used in addition or instead. The example shaft portion 62 is threaded. As perhaps best shown in FIGS. 8-10, the example second end portion 64 defines a first cylindrical portion 70, a curved portion 72, a second cylindrical portion 74, a first cap retaining groove 76 formed in the second cylindrical portion 74, and a screw drive portion 78.

The example screw cap 42 is a rigid member defining an external surface 80 and an internal surface 82. The external surface 80 defines a drive surface portion 84. The example internal surface 82 defines a second cap retaining groove 86 and a cap drive portion 88.

The first example drive plate assembly 30 comprises a drive plate member 90, a drive plate sleeve 92, and a drive plate assembly screw 94. The drive plate member 90 defines a plate opening 96. The drive sleeve 92 defines a sleeve surface portion 92a, a sleeve surface retaining groove 92b, and sleeve opening 98. The drive sleeve 92 defines a sleeve surface portion 92a and a sleeve surface retaining groove 92b. The drive plate opening 96 defines a drive plate opening surface 96a and a drive plate retaining groove 96b. The drive sleeve defines surface portion 92a is sized and dimensioned to engage a plate opening surface 96a of the drive sleeve 92. In particular, the sleeve surface portion 92a and the plate opening surface 96a comprise at least one edge, thus are non circular (e.g., hex shaped). Accordingly, with the drive sleeve 92 supported within the drive plate opening 96 in the drive plate member 90, the interaction of the drive plate surface 96a and the sleeve surface portion 92a prevents both movement of the drive plate sleeve 92 relative to the drive plate member 90 in a first direction along the drive axis D and rotation of the drive sleeve 92 relative to the drive plate member 90 about the drive axis D. The example drive plate screw 94 is further arranged in at least a portion of the sleeve surface retaining groove 92b and drive plate retaining groove 96b to engage the drive plate member 90 and the drive sleeve 92. The drive plate screw 94 prevents movement of the drive plate sleeve 92 in a second direction along the drive axis D relative to the drive plate member 90 during normal use of the king pin press tool 20.

Referring now to the assembly and operation of the first example drive screw assembly 36, the example cap retaining member 46 is configured to be arranged at least partly within the first cap retaining groove 76 and at least partly within the second cap retaining groove 86.

The example drive cap 42 is detachably attached to the example drive screw 40 by arranging the cap retaining member 46 partly within one of the first and second cap retaining grooves 76 and 86 and then displacing the drive cap 42 such that the screw drive portion 78 is adjacent to or in contact with the cap drive portion 88. With the screw drive portion 78 is adjacent to or in contact with the cap drive portion 88, the first and second cap retaining grooves 76 and 86 substantially face each other. The example cap retaining member 46 is formed by a resilient O-ring that compresses to allow the cap retaining member 46 to be partly received within the first and second cap retaining grooves 76 and 86 as depicted in FIGS. 8-10.

When the example drive screw cap 42 is arranged within the first and second cap retaining grooves 76 and 86, the example cap retaining member 46 engages the example first and second cap retaining grooves 76 and 86 to form an interference fit that inhibits movement of the drive screw cap 42 along the drive axis D away from the drive screw 40. However, the resiliency of the example cap retaining member 46 allows the drive screw cap 42 to be easily removed from the drive screw 40 by deliberately applying force on the drive screw cap 42 along the drive axis D away from the drive screw 40 that compresses or otherwise deforms the cap retaining member 46 to overcome the interference fit between the example cap retaining member 46 and the example first and second cap retaining grooves 76 and 86, thereby allowing movement of the drive screw cap 42 along the drive axis D away from the drive screw 40.

The first and second cap retaining grooves 76 and 86, the cap retaining member 46, the screw drive portion 78, and the drive surface portion 84 are all configured to detachably attach the drive screw cap 42 to the drive screw 40 while allowing rotation of the drive screw cap 42 about the drive axis D relative to the drive screw 40. The ability of the drive screw cap 42 to rotate about the drive axis D reduces wear on the drive screw 40 by distributing drive loads applied by the drive screw 40 to the king pin 22 through drive screw cap 42 over a larger surface area. In particular, the drive loads are applied through the screw drive portion 78 and cap drive portion 88, and the example screw drive portion 78 and cap drive portion 88 are shaped to create a larger surface area for transferring the drive loads. The example screw drive portion 78 and example cap drive portion 88 define complementary non-planar shapes to increase the surface are through which the drive loads are applied. The complementary non-planar shape may be semi-spherical as depicted in FIGS. 5 and 7-10 or other shapes such as pyramidal, semi-ovoid, or the like.

The example drive screw assembly 36 thus reduces, relative to a king pin press tool in which the drive screw comes into direct contact with the king pin, the amount of friction to be overcome and the amount of wear on the second end portion 64 of the drive screw 40 when axially rotating the drive screw 40 to drive the king pin 22. The ability to detachably attach the drive screw cap 42 from the drive screw 40 further allows the drive screw cap 42 to be engineered using shapes and materials that allow the drive screw cap 42 to function as a wear part that can be easily and inexpensively replaced.

The first and second cap retaining grooves 76 and 86, the cap retaining member 46, the screw drive portion 78, and the drive surface portion 84 are all further configured to detachably attach the drive screw cap 42 to the drive screw 40 while allowing angular misalignment of a cap axis C of the drive screw cap 42 relative to the drive axis D as shown by a comparison of FIGS. 8, 9, and 10. Allowing angular misalignment of the cap axis C with the drive axis D, in combination with the complementary non-planar (e.g., semi-spherical) shapes of the example screw drive portion 78 and cap drive portion 88, allows the first example king pin press tool 20 to better accommodate slight misalignments between the drive axis D and a longitudinal pin axis P defined by the king pin 22. In particular, by accommodating slight misalignments between the drive axis D and a longitudinal pin axis P defined by the king pin 22, wear on the second end portion 64 of the drive screw 40 is substantially reduced relative to a drive screw without a separate drive screw cap.

The ability of the drive screw cap 42 to rotate about and to be angularly displaced relative to the drive axis D thus reduces wear on the drive screw 40. And the drive screw cap 42 can be engineered with shapes and materials that allow the drive screw cap 42 to be made as an easily replaceable sacrificial part that can obviate the need to replace the entire drive screw 40.

### II. Second Example King Pin Press Tool

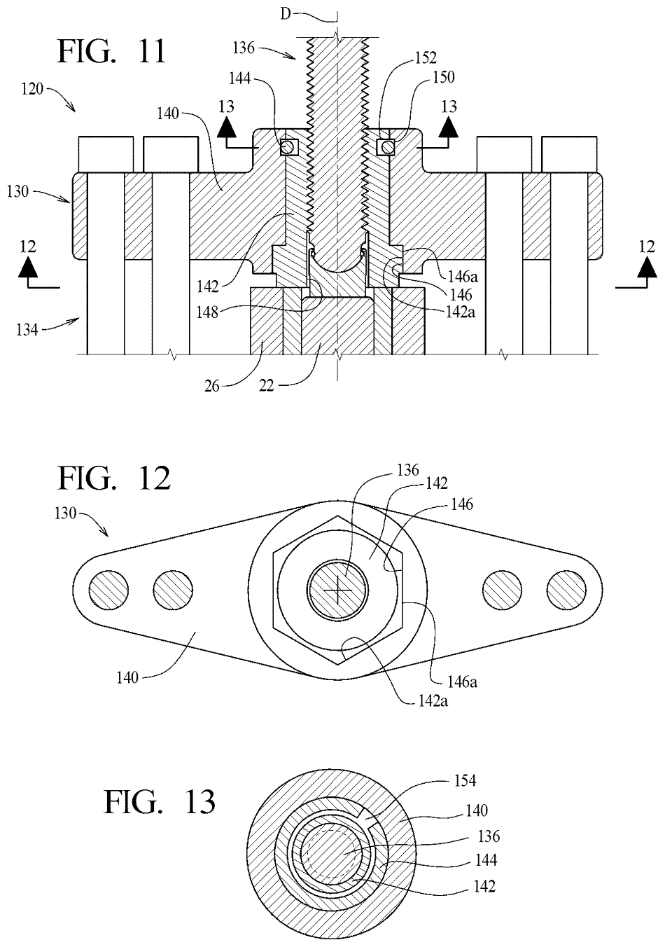

Referring now to FIGS. 11-13 of the drawing, depicted therein is a portion of a second example king pin press tool 120 for displacing the king pin 22 relative to the axle 24 and the knuckle assembly 26 as generally described above. The second example king pin press tool 120 is operated in the same basic manner as the first example king pin press tool 20 described above. The second example king pin press tool 120 will thus be described herein only to the extent that the second example king pin press tool 120 differs from the first example king pin press tool 20.

The second example king pin press tool 120 comprises a second example drive plate assembly 130, an anchor plate (not shown), a spacing system 134, a first example drive screw assembly 136, and a stabilizing system (not shown). The anchor plate, spacing system, drive screw assembly, and stabilizing system of the second example king pin press tool 120 are or may be constructed in the same basic manner as the anchor plate 32, spacing system 34, drive screw assembly 36, and stabilizing system 38 described above and will not be described again herein in detail.

The second example drive plate assembly 130 comprises a drive plate member 140, a drive plate sleeve 142, and a drive plate retaining member 144. The drive plate member 140 defines a sleeve opening 146, while the drive plate sleeve 142 defines a drive opening 148. The drive plate sleeve 142 is further configured to define a plate surface portion 142a that is sized and dimensioned to engage a sleeve surface portion 146a of the drive sleeve 142. In particular, the plate surface portion 142a and the sleeve surface portion 146a are non-circular (e.g., hex shaped). Accordingly, with the drive sleeve 142 supported within the sleeve opening 146 in the drive plate member 140, the interaction of the sleeve surface portion 146a and the plate surface portion 142a secures the drive sleeve 142 in a desired orientation relative to the drive plate member 140. With the drive sleeve 142 in the desired orientation relative to the plate member 140, both movement of the drive plate sleeve 142 relative to the drive plate member 140 in a first direction along the drive axis D and rotation of the drive plate sleeve 142 relative to the drive plate member 140 about the drive axis D are substantially prevented.

In addition, a first plate retaining groove 150 is formed in the example drive plate member 140, and a second plate retaining groove 152 is formed in the example drive plate sleeve 142. When the example drive plate sleeve 142 is arranged in the desired orientation relative to the drive plate member 140, the retaining member 144 is arranged at least partly within the first and second plate retaining grooves 150 and 152. With the retaining member 144 arranged at least partly within the first and second plate retaining grooves 150 and 152, movement of the drive plate sleeve 142 along the drive axis D relative to the drive plate member 140 is substantially prevented.

The example retaining member 144 takes the form of a circular spring that includes a spring gap 154 that allows the retaining member 144 to be deformed and arranged within the second plate retaining groove 152 as the drive sleeve 142 is arranged within the sleeve opening 146 defined by the drive plate member 140. When the drive sleeve 142 is in the desired orientation relative to the drive plate member 140, the first and second plate retaining grooves 150 and 152 are aligned, and the circular spring forming the retaining member 144 expands such that the retaining member 144 lies at least partly within the first and second plate retaining grooves 150 and 152 as shown in FIGS. 11-13. With the retaining member 144 at least partly within the first and second plate retaining grooves 150 and 152, the retaining member inhibits movement of the drive plate sleeve 142 in a second direction along the drive axis D relative to the drive plate member 140. A drive screw member may be used in place of the drive screw assembly 136 depicted in FIG. 11.

During normal use of the second example king pin press tool 120, loads are applied to the drive plate sleeve 142 in the first direction along the drive axis D to such that the drive sleeve surface portion 146a is forced against the drive sleeve surface portion 142a. However, when drive plate assembly 130 of the second example king pin press tool 120 is inadvertently reversed, loads are applied to the drive plate sleeve 142 such that the drive sleeve surface portion 146a is forced away from the drive sleeve surface portion 142a. In this situation, the drive forces are initially transferred from the drive plate sleeve 142 to the drive plate member 140 through the retaining member 144. But the engagement of the retaining member 144 with the first and second plate retaining grooves 150 and 152 is insufficient to transfer the drive loads, so the retaining member 144 fails and releases the drive plate sleeve 142 from the drive plate member 140 without substantially damaging the major components of the second example king pin press tool 120. Only the retaining member 144 need be replaced if the second example king pin press tool 120 is used with the drive plate assembly 130 inadvertently reversed.

What is claimed is:

1. A press tool for displacing a pin member relative to a structural member, the press tool comprising:
a drive plate assembly comprising
a drive plate defining a drive plate opening, and
a drive sleeve defining a drive sleeve surface and drive sleeve opening,
a drive screw assembly comprising
a drive screw member defining a drive axis, and
a drive screw cap configured to engage at least a portion of the drive screw member;
an anchor plate;
a spacing system; wherein
the drive sleeve surface is configured to engage the drive plate opening such that movement of the drive sleeve relative to the drive plate is inhibited;
the spacing system is configured to support the drive plate and the anchor plate relative to the pin member such that the drive screw cap engages at least a portion of the pin member; and
the drive screw member engages the drive sleeve opening such that rotation of the drive screw member relative to the drive plate assembly displaces the drive screw member through the drive sleeve opening to displace the pin member along the drive axis relative to the structural member.

2. The press tool of claim 1, in which
the drive plate defines a first retaining groove;
the drive sleeve defines a second retaining groove; and
the drive plate assembly comprises a drive plate retaining member configured to fit within at least a portion of the first retaining groove and at least a portion of the second retaining groove.

3. The press tool of claim 2, in which the drive plate retaining member is a screw.

4. The press tool of claim 2, in which the drive plate retaining member is an O-ring.

5. The press tool of claim 1, in which the drive screw assembly comprises a cap retaining member configured to engage at least a portion of the drive screw member and at least a portion of the drive screw cap.

6. The press tool of claim 1, in which
the drive screw member defines a first cap retaining groove,
the drive cap member defines a second cap retaining groove, and
the drive screw assembly further comprises a cap retaining member configured to engage at least a portion of the first and second cap retaining grooves.

7. The press tool of claim 1, in which
the drive plate opening defines at least one plate opening edge;
the drive sleeve surface defines at least one sleeve opening edge;
the at least one plate opening edge is configured to engage the at least one sleeve opening edge.

8. A press tool for displacing a pin member relative to a structural member, the press tool comprising:
a drive plate assembly comprising
a drive plate defining a drive plate opening,
a drive sleeve defining a drive sleeve surface and drive sleeve opening, and
a drive retaining member;
a drive screw assembly comprising
a drive screw member defining a drive axis, and
a drive screw cap configured to engage at least a portion of the drive screw member;
an anchor plate;
a spacing system; wherein
the drive retaining member is configured to engage at least a portion of the drive sleeve surface and at least a portion of the drive plate opening such that movement of the drive sleeve relative to the drive plate is inhibited;
the spacing system is configured to support the drive plate and the anchor plate relative to the pin member such that the drive screw cap engages at least a portion of the pin member; and
the drive screw member engages the drive sleeve opening such that rotation of the drive screw member relative to the drive plate assembly displaces the drive screw member through the drive sleeve opening to displace the pin member along the drive axis relative to the structural member.

9. The press tool of claim 8, in which
the drive plate defines a first retaining groove;
the drive sleeve defines a second retaining groove; and
the drive plate retaining member configured to fit within at least a portion of the first retaining groove and at least a portion of the second retaining groove.

10. The press tool of claim 9, in which the drive plate retaining member is a screw.

11. The press tool of claim 9, in which the drive plate retaining member is an o-ring.

12. The press tool of claim 8, in which the drive screw assembly comprises a cap retaining member configured to engage at least a portion of the drive screw member and at least a portion of the drive screw cap.

13. The press tool of claim 8, in which
the drive screw member defines a first cap retaining groove,
the drive cap member defines a second cap retaining groove, and
the drive screw assembly further comprises a cap retaining member configured to engage at least a portion of the first and second cap retaining grooves.

14. The press tool of claim 8, in which
the drive plate opening defines at least one plate opening edge;
the drive sleeve surface defines at least one sleeve opening edge;
the at least one plate opening edge is configured to engage the at least one sleeve opening edge.

15. A method for displacing a pin member relative to a structural member, the method comprising the steps of:
providing a drive plate assembly, the drive plate assembly comprising
a drive plate defining a drive plate opening, and
a drive sleeve defining a drive sleeve surface and drive sleeve opening,
providing a drive screw assembly, the drive screw assembly comprising a drive screw member defining a drive axis, and
a drive screw cap configured to engage at least a portion of the drive screw member;
providing an anchor plate;
providing a spacing system;
configuring the drive sleeve surface to engage the drive plate opening such that movement of the drive sleeve relative to the drive plate is inhibited;
configuring the spacing system to support the drive plate and the anchor plate relative to the pin member such that the drive screw cap engages at least a portion of the pin member; and
configuring the drive screw member to engage the drive sleeve opening such that rotation of the drive screw member relative to the drive plate assembly displaces the drive screw member through the drive sleeve opening to displace the pin member along the drive axis relative to the structural member.

16. The method of claim 15, in which the step of providing a drive plate assembly comprises:
configuring the drive plate to define a first retaining groove;
configuring the drive sleeve to define a second retaining groove; and
providing a drive plate retaining member configured to fit within at least a portion of the first retaining groove and at least a portion of the second retaining groove.

17. The press tool of claim 15, in which the step of providing the drive screw assembly comprises providing a cap retaining member configured to engage at least a portion of the drive screw member and at least a portion of the drive screw cap.

18. The press tool of claim 15, in which the step of providing a drive screw assembly comprises:
configuring the drive screw member to define a first cap retaining groove,
configuring the drive cap member to define a second cap retaining groove, and
arranging a cap retaining member to engage at least a portion of the first and second cap retaining grooves.

19. The press tool of claim 15, in which the step of providing the drive plate assembly comprises
configuring the drive plate opening to define at least one plate opening edge;
configuring the drive sleeve surface to define at least one sleeve opening edge;
configuring the at least one plate opening edge to engage the at least one sleeve opening edge.
